(19) United States
(12) Patent Application Publication
(10) Pub. No.: US 2026/0093723 A1
(43) Pub. Date: Apr. 2, 2026

(54) Natural Language Prompt Interface

(71) Applicant: Ordr Inc., Santa Clara, CA (US)

(72) Inventors: Sakthi Dasan Sekar, Chennai (IN); Gnanaprakasam Pandian, Cupertino, CA (US); Sheausong Yang, Saratoga, CA (US)

(73) Assignee: Ordr Inc., Santa Clara, CA (US)

(21) Appl. No.: 18/901,469

(22) Filed: Sep. 30, 2024

(51) Int. Cl. G06F 16/332; G06F 16/33; G06F 16/338

(52) U.S. Cl. CPC G06F 16/3329; G06F 16/3344; G06F 16/338

(57) ABSTRACT

Techniques for implementing a natural language query interface that enables interaction with a computer system through natural language inputs are disclosed. In some embodiments, a method comprises the following: receiving a first user input comprising a first natural language prompt; generating a first instruction for a Large Language Model (LLM) to determine a first user intent category of the first natural language prompt; submitting the first instruction to the LLM, wherein the LLM determines the first user intent category based on the first natural language prompt; receiving the first user intent category from the LLM; mapping the first user intent category, received from the LLM, to a first particular process of a set of processes; and executing the first particular process in response to receiving the first user input.

### TECHNICAL FIELD

The present disclosure relates to a system that implements a natural language prompt interface. In particular, the present disclosure relates to a system that uses a large language model to determine an intent of a natural language prompt in implementing a user interface that processes natural language prompts.

### BACKGROUND

A natural language is any language that occurs naturally in a human community by a process of use, repetition, and change without conscious planning or premeditation such as the native speech of a people. A natural language prompt is natural language text that describes a task to be performed by a computer system. Natural language prompts may be input into artificial intelligence models to generate responses.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for implementing a natural language prompt interface accordance with one or more embodiments;

FIG. 3 illustrates another example set of operations for implementing a natural language prompt interface in accordance with one or more embodiments;

FIG. 4A illustrates an example graphical user interface (GUI) in which user input is received in accordance with one or more embodiments;

FIG. 4B illustrates an example GUI in which a response to the user input is presented in accordance with one or more embodiments; and

FIG. 5 a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. SYSTEM ARCHITECTURE
3. IMPLEMENTING A NATURAL LANGUAGE PROMPT INTERFACE
4. EXAMPLE EMBODIMENTS
5. COMPUTER NETWORKS AND CLOUD NETWORKS
6. HARDWARE OVERVIEW
7. MISCELLANEOUS; EXTENSIONS

### 1. General Overview

One or more embodiments include a system that implements a natural language prompt interface. The system receives user input that includes a natural language prompt. In some embodiments, the system generates an instruction for a large language model (LLM) to determine a user intent category of the natural language prompt and submits the instruction to the LLM. The LLM determines the user intent category based on the natural language prompt. Next, the system receives the user intent category from the LLM and maps the user intent category to a particular process of a set of processes. The system then executes the particular process in response to receiving the user input.

In an embodiment, the system maps the user intent category to the particular process by applying a hash function to the user intent category to select the particular process. In one or more embodiments, the instruction generated by the system identifies a plurality of pre-defined intent categories from which the LLM is to select the user intent category. Each of the plurality of pre-defined intent categories has been previously mapped to one of the processes in the set of processes.

In some embodiments, the user intent category comprises an action command to apply a modification to a data repository, and the particular process comprises applying the modification to the data repository. In other embodiments, the user intent category comprises a request for information, and the particular process comprises presenting information on a computing device. In further embodiments, the user intent category comprises a database query, and the particular process comprises executing the database query. In other embodiments, the user intent category comprises a request for information to address an informational technology (IT) issue, and the particular process comprises presenting the information to address the IT issue in response to the natural language prompt. In further embodiments, the user intent category comprises a query of vulnerabilities for a computing resource, and the particular process comprises presenting a response to the query of vulnerabilities for the computing resource in response to the natural language prompt.

In one or more embodiments, the system determines a user context that corresponds to the natural language prompt or to the particular process that was last executed by the system, and then generates an instruction to the LLM for the LLM to generate a recommendation for an action, where the instruction includes the user context. Next, the system submits the instruction to the LLM for the LLM to generate the recommendation for the action. The system then receives the recommendation for the action from the LLM and presents the recommendation for the action in response to executing the particular process. In one or more embodiments, presenting the recommendation for the action includes presenting a selectable user interface element that is configured to trigger execution of the action in response to its selection. In an embodiment, the action comprises installing software, uninstalling software, changing a configuration setting on a computing device, or adding a computing resource to a dashboard.

In some embodiments, the system receives an additional user input comprising an additional natural language prompt and generates an additional instruction for the LLM to determine an additional user intent category of the additional natural language prompt. Next, the system submits the additional instruction to the LLM, and the LLM determines the additional user intent category based on the additional natural language prompt. The system then receives the additional user intent category from the LLM and maps the additional user intent category to another particular process of the set of processes. The system then executes the other particular process in response to receiving the additional user input.

The LLM may be configured to determine multiple user intent categories for a single natural language prompt. In an embodiment, the LLM determines an additional user intent category based on the natural language prompt, and the system receives the additional user intent category from the LLM in response to the submitting the instruction to the LLM. The system then maps the additional user intent category to another particular process of the set of processes and executes the other particular process in response to receiving the user input.

One or more embodiments described in this Specification and/or recited in the claims may not be included in this General Overview section.

### 2. System Architecture

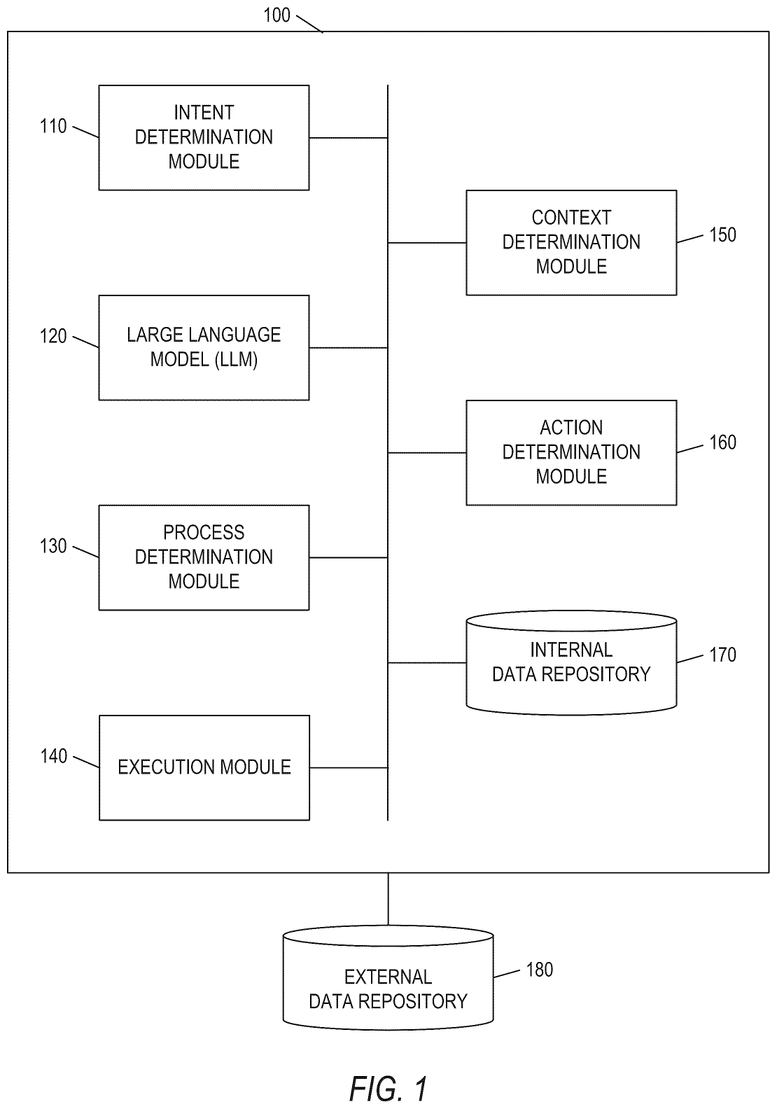

FIG. 1 illustrates a system 100 in accordance with one or more embodiments. As illustrated in FIG. 1, system 100 includes an intent determination module 110, a large language model (LLM) 120, a process determination module 130, an execution module 140, a context determination module 150, an action determination module 160, and an internal data repository 170. In one or more embodiments, the system 100 may include more or fewer components than the components illustrated in FIG. 1. The components illustrated in FIG. 1 may be local to or remote from each other. The components illustrated in FIG. 1 may be communicatively coupled to each other via a direct connection or via a network. In some embodiments, the system 100 is communicatively coupled to an external data repository 180. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, the components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, the internal data repository 170 and the external data repository 180 may be any type of storage unit and/or device (e.g., a file system, database, collection of tables, or any other storage mechanism) for storing data. Furthermore, the internal data repository 170 and the external data repository 180 may include multiple different storage units and/or devices. The multiple different storage units and/or devices may or may not be of the same type or located at the same physical site.

The system 100 is configured to receive a user input comprising a natural language prompt and generate a set of one or more results in response to the user input. In one or more embodiments, the user input is received from a computing device connected to the system 100 such as via a computer network. In one example, a user of the computing device provides the user input as audio input by speaking into a microphone of the computing device. In another example, the user of the computing device provides the user input as text by typing the text using a keyboard of the computing device. Other types of user input and other devices for collecting the user input are also within the scope of the present disclosure.

In one or more embodiments, the natural language prompt includes natural language text that describes a task to be performed by a computer system. For example, the task may include executing a query on the internal data repository 170. In some embodiments, the internal data repository 170 stores data managed by a Cyber Asset Attack Surface Management (CAASM) system. A CAASM system helps organizations identify and manage potential vulnerabilities in their assets, such as computing devices, hardware, cloud assets, and applications. The CAASM system may consolidate and normalize asset data. The asset data may include a corresponding identifier for each asset being managed, as well as attributes (e.g., technical specifications) of the asset and other data (e.g., usage data) related to the asset. In an embodiment, the asset data is stored in the internal data repository 170. In other embodiments, the internal data repository 170 stores other types of data other than the asset data discussed above. For example, the internal data repository 170 may store documents that include information used to address IT issues, such as documents comprising commonly asked questions about IT problems and answers to those questions.

In some embodiments, the internal data repository 170 stores data in tables. For example, the internal data repository 170 may comprise a database that stores each of a plurality of datasets in a corresponding table of the internal data repository 170 (e.g., a first dataset is stored in a first table, a second dataset is stored in a second table, a third dataset is stored in a third table, and so on and so forth). However, the internal data repository 170 may store data in other ways as well.

In an embodiment, the external data repository 180 is hosted and maintained outside of the system 100. The external data repository 180 may be isolated from the system 100 by a firewall or some other type of network security device that regulates network traffic. In some embodiments, the external data repository 180 may include a Common Vulnerabilities and Exposures (CVE) database that stores information identifying or otherwise indicating known vulnerabilities and exposures for computing resources. The CVE database may store documentation that includes unique identifiers for publicly known vulnerabilities in publicly released software packages and other computing resources, as well as a brief description of the corresponding vulnerabilities. The external data repository 180 may store other types of data as well.

In one or more embodiments, the intent determination module 110 is configured to determine a user intent category for the natural language prompt. The intent determination module 110 may determine the user intent category of the natural language prompt using the LLM 120. In an embodiment, the intent determination module 110 is configured to generate an instruction for the LLM 120 to determine the user intent category of the natural language prompt and send, or otherwise submit, the instruction to the LLM 120. The instruction may include the natural language prompt that was included in the user input. In addition to including the natural language prompt, the instruction may also include a plurality of pre-defined intent categories from which the LLM 120 is to select the user intent category of the natural language prompt.

One example of a user intent category is an action command to apply a modification to a data repository. For example, the natural language prompt may include an instruction to update data in the internal data repository 170, delete data from the internal data repository 170, or insert new data into the internal data repository. The intent determination module 110 may use the LLM 120 to categorize the intent of this natural language prompt as an action command to apply a modification to a data repository.

Another example of a user intent category is a request for information. For example, the natural language prompt may include an instruction to obtain a particular type of information. The intent determination module 110 may use the LLM 120 to categorize the intent of this natural language prompt as a request for information. One or more specific types of requests for information may be used as user intent categories. In an embodiment, one of the user intent categories that may be determined for the natural language prompt comprises a database query. For example, the natural language prompt may include a request for a list of devices associated with a particular user, which involves querying a database that stores the information necessary for processing such a request. In another embodiment, one of the user intent categories that may be determined for the natural language prompt comprises a request for information to address an informational technology (IT) issue. For example, the natural language prompt may include a request for information regarding how to import a particular type of data from a particular data source into a particular IT management system. In yet another embodiment, one of the user intent categories that may be determined for the natural language prompt comprises a query of vulnerabilities for a computing resource. For example, the natural language prompt may include a request for a list of vulnerabilities of a particular operating system.

In some embodiments, the LLM 120 is configured to determine the user intent category of the natural language prompt based on the instruction generated by and received from the intent determination module 110. The LLM 120 is a machine learning model that performs natural language processing tasks to process human language, such as the natural language prompt and the instruction to determine the user intent category of the natural language prompt. In one embodiment, the LLM 120 uses a deep neural network to generate outputs based on patterns learned from training data. The LLM 120 may include an implementation of a transformer-based architecture. In contrast to recurrent neural networks that use recurrence as the main mechanism for capturing relationships between tokens in a sequence, transformer-based neural networks use self-attention as their mechanism for capturing relationships. Other implementations of the LLM 120 are also within the scope of the present disclosure. In an embodiment, the LLM 120 is configured to determine multiple user intent categories for a single natural language prompt. For example, the LLM 120 may determine a first user intent category and a second user intent category for a single natural language prompt.

In one or more embodiments, the process determination module 130 is configured to determine a particular process based on the user intent category determined by the LLM 120. The process determination module 130 may select the particular process from a set of processes. The set of processes may be stored in and accessed from the internal data repository 170. However, the set of processes may be stored and accessed in other ways as well. In some embodiments, the process determination module 130 is configured to determine the particular process by mapping the user intent category, received from the LLM 120, to the particular process of the set of processes. In an embodiment, the process determination module 130 maps the user intent category to the particular process by applying a hash function to the user intent category to select the particular process. A hash function takes a group of characters, referred to as a key, and maps it to a value of a certain length, referred to as a hash value. The hash value may then be used to index a hash table. The hash code acts as a pointer or index to the actual data in the hash table. For example, the hash function may translate the user intent category into a hash value that is used to identify the particular process within the hash table. Other ways of determining the particular process based on the user intent category are also within the scope of the present disclosure.

In embodiments in which the LLM 120 determines more than one user intent category, the process determination module 130 may determine a corresponding particular process for each user intent category determined by the LLM 120. For example, if the LLM 120 determines a first user intent category and a second user intent category for a single natural language prompt, then the process determination module 130 may determine a first particular process for the first user intent category and a second particular process for the second user intent category. The process determination module 130 may use the mapping technique discussed above to determine the corresponding particular process for each of the multiple user intent categories determined by the LLM 120.

In some embodiments, the execution module 140 is configured to execute the particular process in response to receiving the user input. In embodiments in which multiple particular processes are determined by the process determination module 130 for the same natural language prompt, the execution module 140 may execute all of the multiple particular processes determined by the process determination module 130. The execution module 140 may execute the particular process by communicating instructions to another component to perform one or more operations of the particular process. In an embodiment in which the user intent category comprises an action command to apply a modification to the internal data repository 170 and the particular process comprises applying the modification to the internal data repository 170, the execution module 140 may send instructions to the internal data repository 170 to perform one or more operations that are configured to apply the modification to the internal data repository 170. For example, the execution module 140 may send Structured Query Language (SQL) statements (e.g., an UPDATE command, a DELETE command, an INSERT INFO command, a CREATE command, an ALTER command) to a database of the internal data repository 170.

In another embodiment in which the user intent category comprises a request for information and the particular process comprises presenting information on a computing device, the execution module 140 may request the information from a data source, such as from the internal data repository 170, the external data repository 180, or some other component, and then present the information on the computing device. The execution module 140 may present the information on the computing device by displaying the information on the computing device. Alternatively, the execution module 140 may present the set of one or more results in audio form or in some other format on the computing device.

In one or more embodiments, the context determination module 150 is configured to determine a user context of the user of the system 100. The user context may characterize the current state of the user's interaction with the system 100. In an embodiment, the user context corresponds to and is derived from the natural language prompt. For example, the context determination module 150 may be configured to execute an embedding operation to generate a feature vector corresponding to the natural language prompt, and then compare the feature vector to each of a set of feature vectors corresponding respectively to a set of user contexts to identify the feature vector of the user context that is the most similar to the feature vector of the natural language prompt. The context determination module 150 may determine that the user context of which the corresponding feature vector is most similar to the feature vector of the natural language prompt is the user context of the user.

In another embodiment, the user context corresponds to and is derived from the particular process executed by the execution module 140. For example, the context determination module 150 may be configured to execute an embedding operation to generate a feature vector corresponding to an identification (e.g., a name) of the particular process, and then compare the feature vector to each of a set of feature vectors corresponding respectively to a set of user contexts to identify the feature vector of the user context that is the most similar to the feature vector of the particular process. The context determination module 150 may determine that the user context of which the corresponding feature vector is most similar to the feature vector of the particular process is the user context of the user.

In some embodiments, the context determination module 150 may use the LLM 120 to determine the user context. For example, the context determination module 150 may generate an instruction for the LLM 120 to determine a user context and then submit the instruction to the LLM 120. In one or more embodiments, the instruction includes context information that characterizes the current state of the user's interaction with the system 100. The context information may include the natural language prompt or an identification of the particular process. The instruction may further include a set of user contexts from which the LLM 120 may select the user context that corresponds to the context information that is included in the instruction. The LLM 120 may be configured to determine the user context based on the context information and return the user context to the context determination module 150.

In one or more embodiments, the action determination module 160 is configured to determine a recommendation for an action based on the user context that was determined by the context determination module 150. The action determination module 160 may use the LLM 120 to determine the recommendation for the action. In an embodiment, the action determination module 160 generates an instruction to the LLM 120 for the LLM 120 to generate a recommendation for an action. The instruction includes the user context. The action determination module 160 may be configured to submit the instruction to the LLM 120 for the LLM 120 to generate the recommendation for the action.

In some embodiments, the execution module 140 is configured to present the recommendation for the action determined by the action determination module 160. For example, the execution module 140 may display the recommendation for the action on a computing device. In an embodiment, the execution module 140 is configured to present a selectable user interface element that is configured to trigger execution of the action in response to its selection. For example, the execution module 140 may be configured to display a selectable button configured to perform the recommended action in response to its selection. Other types of selectable user interface elements are also within the scope of the present disclosure.

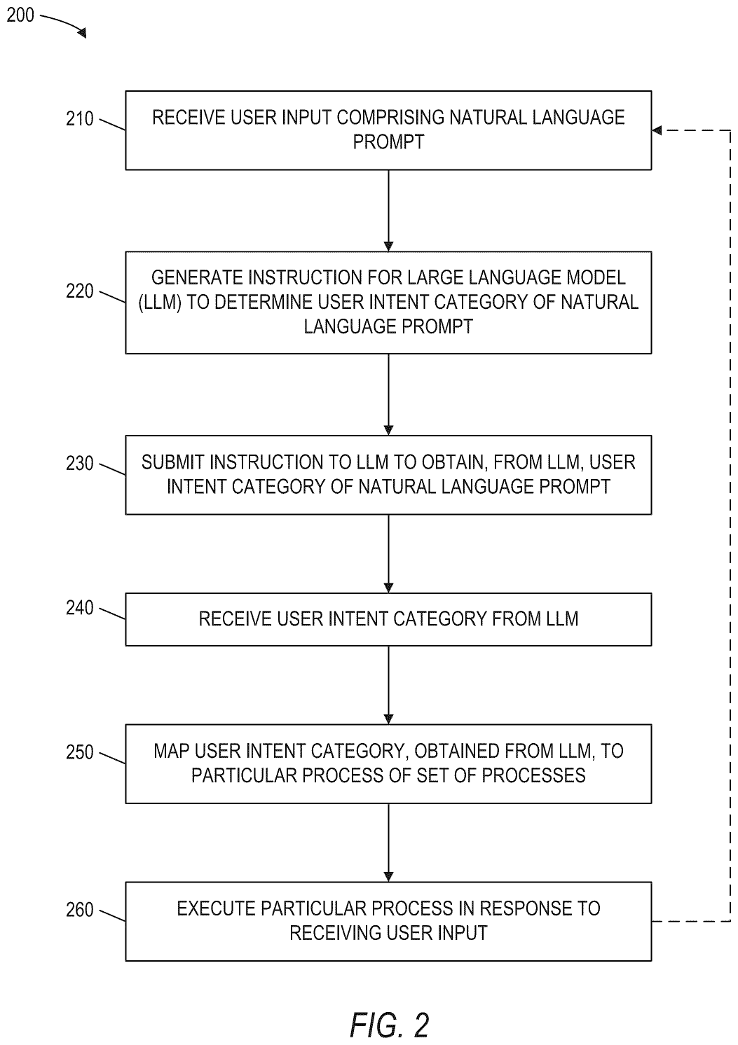

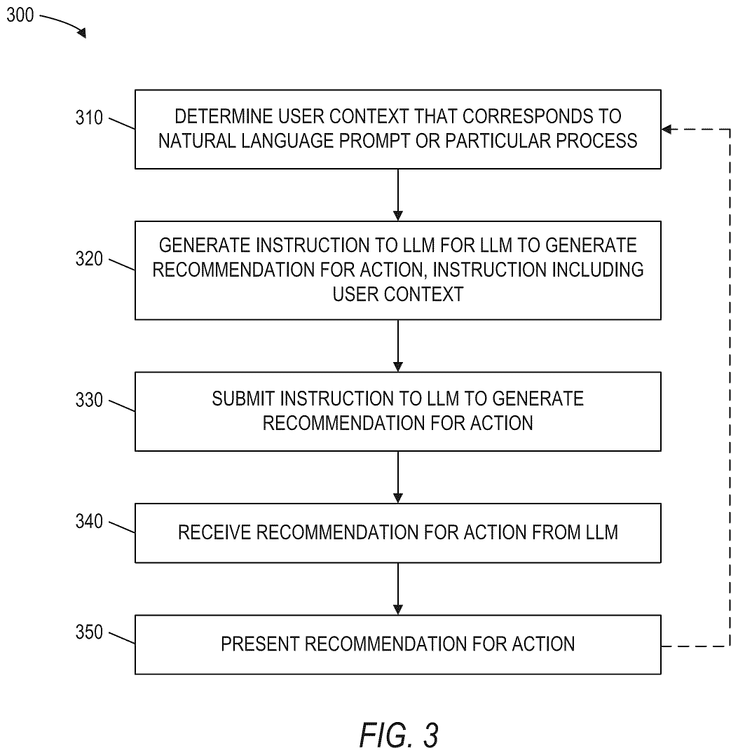

In one or more embodiments, the system 100 refers to hardware and/or software configured to perform operations described herein for implementing a natural language prompt interface. Examples of operations for implementing a natural language prompt interface, as well as further details of the features and functions of the system 100, are described below with reference to FIGS. 2 and 3.

Additional embodiments and/or examples relating to computer networks are described below in Section 5, titled “Computer Networks and Cloud Networks.”

### 3. Integrating Dataset Schemas With Natural Language Prompts for Enhanced Query Generation

FIG. 2 illustrates an example set of operations 200 for implementing a natural language prompt interface in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system 100 receives a user input comprising a natural language prompt (Operation 210). The user input is received from a computing device connected to the system 100 (e.g., via a computer network). The user input may be provided by the user in a variety of different formats. For example, the user input may be provided as audio input by the user speaking into a microphone of the computing device. The user of the computing device may also provide the user input as text by typing the text using a keyboard of the computing device. Other types of user input and other devices for collecting the user input are also within the scope of the present disclosure.

In one or more embodiments, the system 100 generates an instruction for the LLM 120 to determine a user intent category of the natural language prompt (Operation 220). The instruction may include the natural language prompt that was included in the user input. The instruction may also identify a plurality of pre-defined user intent categories from which the LLM 120 is to select the user intent category. The some embodiments, the user intent categories include one or more of an action command to apply a modification to a data repository, a request for information, a database query, a request for information to address an IT issue, or a query of vulnerabilities for a computing resource. Other user intent categories are also within the scope of the present disclosure.

In some embodiments, the system 100 submits the instruction to the LLM 120 (Operation 230). In one example, the system 100 feeds the instruction as input into the LLM 120. In an embodiment in which the LLM 120 is external to the system 100, the system 100 transmits the instruction via a network connection (e.g., the Internet) to the external system in which the LLM 120 is running as part of a request to determine the user intent category for the natural language prompt. In response to the system 100 submitting the instruction to the LLM 120, the LLM 120 determines the user intent category based on the natural language prompt.

In an embodiment, the system 100 receives the user intent category from the LLM 120 (Operation 240). The system 100 may receive the user intent category from the LLM 120 in response to the LLM 120 executing the instruction, received from the system 100, to determine the user intent category of the natural language prompt. In embodiments in which the LLM 120 determines multiple user intent categories for the same natural language prompt, the system 100 receives the multiple user intent categories. For example, the system 100 may receive a first user intent category and a second user intent category for the same natural language prompt.

In one or more embodiments, the system 100 maps the user intent category, received from the LLM 120, to a particular process of a set of processes (Operation 250). For example, the system 100 may store a mapping of pre-defined user intent categories to corresponding processes and use the mapping to identify the particular process to which the user intent category, received from the LLM 120, maps. In an embodiment, the system 100 maps the user intent category to the particular process by applying a hash function to the user intent category to select the particular process. Other ways of mapping the user intent category to the particular process are also within the scope of the present disclosure. In embodiments in which the system 100 receives multiple user intent categories from the LLM 120, the system 100 maps each of the multiple user intent categories to a corresponding particular process.

In some embodiments, the system 100 executes the particular process in response to receiving the user input (Operation 260). The system 100 may execute the particular process by communicating instructions to a component within the system 100 or to a component external to the system 100 to perform one or more operations of the particular process. For example, the system 100 may send instructions or a request to the internal data repository 170 or to the external data repository 180 to perform one or more operations of the particular process.

In an embodiment in which the user intent category comprises an action command to apply a modification to the internal data repository 170 and the particular process comprises applying the modification to the internal data repository 170, the system 100 may send instructions to the internal data repository 170 to perform one or more operations that are configured to apply the modification to the internal data repository 170. For example, the system 100 may send Structured Query Language (SQL) statements (e.g., an UPDATE command, a DELETE command, an INSERT INFO command, a CREATE command, an ALTER command) to a database of the internal data repository 170.

In another embodiment in which the user intent category comprises a request for information and the particular process comprises presenting information on a computing device, the system 100 may request the information from a data source, such as from the internal data repository 170, the external data repository 180, or some other component, and then present the information on the computing device. The system 100 may present the information on the computing device by displaying the information on the computing device. Alternatively, the system 100 may present the set of one or more results in audio form or in some other format on the computing device.

In some embodiments in which the user intent category comprises a database query and the particular process comprises executing the database query, the system 100 executes the database query using an LLM to generate the specific database query based on the natural language prompt. In one example, the system 100 generates an instruction for the LLM to generate the database query at least by executing an embedding operation to generate a feature vector corresponding to the natural language prompt. In this example, the system 100 compares the feature vector of the natural language prompt to each of a set of feature vectors corresponding respectively to a set of database schemas of a database to determine that a subset of feature vectors, of the set of feature vectors, meets a similarity criteria in relation to the feature vector of the natural language prompt. In response to determining that the subset of feature vectors meet the similarity criteria in relation to the feature vector of the natural language prompt, the system 100 may select a subset of database schemas that correspond to the subset of feature vectors for generation of the instruction, and then generate the instruction to the LLM for the LLM to generate the database query. The instruction may specify the natural language prompt and the subset of database schemas. In one or more embodiments, the system 100 submits the instruction to the LLM for the LLM to generate the database query, and then receives the database query from the LLM. The database query is based on and directed to the subset of database schemas. Next, the system 100 may execute the database query on the database to generate a set of one or more results based on the subset of database schemas, and then present the set of one or more results in response to the natural language prompt.

In an embodiment in which the user intent category comprises a request for information to address an IT issue and the particular process comprises presenting the information in response to the natural language prompt, the system 100 executes the particular process by at least identifying, from a set of documents, one or more documents that are relevant to the IT issue based on a comparison of the one or more documents to the IT issue, and then generating an instruction to the LLM for the LLM to generate the information to address the IT issue. The instruction may include the natural language prompt and the one or more identified documents. Next, the system 100 may submit the instruction to the LLM for the LLM to generate the information to address the IT issue. In one or more embodiments, the system 100 receives the information from the LLM, and then presents the information in response to the first natural language prompt.

In some embodiments in which the user intent category comprises a query of vulnerabilities for a computing resource and the particular process comprises presenting a response to the query of vulnerabilities for the computing resource in response to the natural language prompt, the system 100 executes the particular process by at least identifying one or more attributes of the computing resource, and then obtaining, from a CVE database, information specifying one or more vulnerabilities based on the one or more attributes of the computing resource. The attributes may include technical specification of the computing resource, such as specific hardware or software details. Next, the system 100 may generate an instruction to the LLM for the LLM to generate the response to the query of vulnerabilities for the computing resource. In an embodiment, the instruction includes the natural language prompt and the information specifying the one or more vulnerabilities. In one or more embodiments, the system 100 submits the instruction to the LLM for the LLM to generate the response to the query, receives the response to the query from the LLM, and presents the response to the query in response to the natural language prompt.

Particular processes other than the particular processes discussed above are also within the scope of the present disclosure. After executing the one or more particular processes received from the LLM 120, the system 100 may repeat the set of operations 200. For example, the system 100 may receive another user input comprising another natural language prompt (Operation 210). This subsequent user input may be received from the same user that submitted the previous user input or it may be submitted by a different user.

FIG. 3 illustrates another example set of operations 300 for implementing a natural language prompt interface in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments. The set of operations 300 may be integrated or incorporated into the set of operations 200 in FIG. 2. For example, in some embodiments, the set of operation 300 are executed after the execution of the particular process (Operation 260) in FIG. 2.

In an embodiment, the system 100 determines a user context that corresponds to a natural language prompt that has been submitted by a user or to a particular process that has been executed by the system 100 (Operation 310). The user context may characterize the current state of the user's interaction with the system 100. In one example, a user may submit the natural language prompt “Pull me a list of printers that have not executed any print jobs in the last thirty days” as a natural language prompt to the system 100. In response to the natural language prompt, the system 100 may determine and execute a particular process (e.g., a database query) that generates a list of printers that have not executed any print jobs in the last 30 days and presents the list of printers to the user. In this example, the system 100 may determine that the user context is a database query for a list of printers that have not executed any print jobs within a particular time period.

In some embodiments, the system 100 determines the user context by comparing a feature vector of the natural language prompt or the particular process to each of a set of feature vectors corresponding respectively to a set of user contexts. For example, the system 100 may execute an embedding operation to generate a feature vector corresponding to the natural language prompt or an identifier of the particular process, and then compare the feature vector to each of a set of feature vectors corresponding respectively to a set of user contexts to identify the feature vector of the user context that is the most similar to the feature vector of the natural language prompt or the particular process. The system 100 may then determine that the user context of which the corresponding feature vector is most similar to the feature vector of the natural language prompt is the user context of the user.

In some embodiments, the system 100 uses an LLM to determine the user context. For example, the system 100 may generate an instruction for the LLM 120 to determine the user context and then submit the instruction to the LLM 120. The instruction may include context information that characterizes the current state of the user's interaction with the system 100. For example, the context information may include the natural language prompt. Additionally or alternatively, the context information may include the identification of a particular process that was last executed by the system 100 prior to the system 100 determining the user context. The instruction may further include a set of user contexts from which the LLM 120 may select in determining the user context. The system 100 may submit, to the LLM 120, the instruction for the LLM 120 to determine the user context. The LLM 120 may then determine the user context based on the instruction and return the user context to the system 100.

In an embodiment, the system 100 generates an instruction to the LLM 120 for the LLM 120 to generate a recommendation for an action (Operation 320). The instruction may include the user context. In some embodiments, the instruction includes a list of pre-defined actions from which the LLM 120 is to select for use in generating the recommendation for an action. For example, the instruction may comprise a request to generate a recommendation for an action for the user context using the list of pre-defined actions. The list of pre-defined actions may include a variety of different computer-based operations, including, but not limited to, installing a specific software application, uninstalling a specific software application, changing a specific configuration setting in a specific way on a computing device, and adding a specific computing resource to a specific dashboard.

In one or more embodiments, the system 100 submits the instruction to the LLM 120 for the LLM 120 to generate the recommendation for the action (Operation 330). In one example, the system 100 feeds the instruction as input into the LLM 120. In an embodiment in which the LLM 120 is external to the system 100, the system 100 transmits the instruction via a network connection (e.g., the Internet) to the external system in which the LLM 120 is running as part of a request to generate a recommendation for an action. In response to the system 100 submitting the instruction to the LLM 120, the LLM 120 generates the recommendation for the action.

In an embodiment, the system 100 receives the recommendation for the action from the LLM 120 (Operation 340). The recommendation for the action may comprise a recommendation to install a specific software application, a recommendation to uninstall a specific software application, a recommendation to change a specific configuration setting in a specific way on a computing device, or a recommendation to add a specific computing resource to a specific dashboard (e.g., add an identification of a printer to a dashboard in an IT management tool). Other types of recommendations for other types of actions are also within the scope of the present disclosure.

In an embodiment, the system 100 presents the recommendation for the action in response to the executing of the particular process (Operation 350). For example, the system 100 may display the recommendation for the action on a computing device, such as on the computing device via which the natural language prompt was submitted by the user. In one or more embodiments, as part of presenting the recommendation for the action, the system 100 presents a selectable user interface element that is configured to trigger execution of the action in response to its selection. For example, the system 100 may display a selectable button configured to perform the recommended action in response to its selection. Other types of selectable user interface elements are also within the scope of the present disclosure.

In an example in which the recommendation for the action includes a recommendation to install a specific software application, the system 100 may display a selectable button configured to trigger an installation process for the specific software application in response to the selection of the selectable button. In an example in which the recommendation for the action includes a recommendation to uninstall a specific software application, the system 100 may display a selectable button configured to trigger removal process for the specific software application in response to the selection of the selectable button. In an example in which the recommendation for the action includes a recommendation to change a specific configuration setting in a specific way on a computing device, the system 100 may display a selectable button configured to trigger the specified configuration change in response to the selection of the selectable button. In an example in which the recommendation for the action includes a recommendation to add a specific computing resource to a specific dashboard, the system 100 may display a selectable button configured to trigger the addition of the specific computing resource to the specific dashboard in response to the selection of the selectable button.

### 4. Example Embodiments

Detailed examples are described below for purposes of clarity. Components and/or operations described below should be understood as one specific example that may not be applicable to certain embodiments. Accordingly, components and/or operations described below should not be construed as limiting the scope of any of the claims.

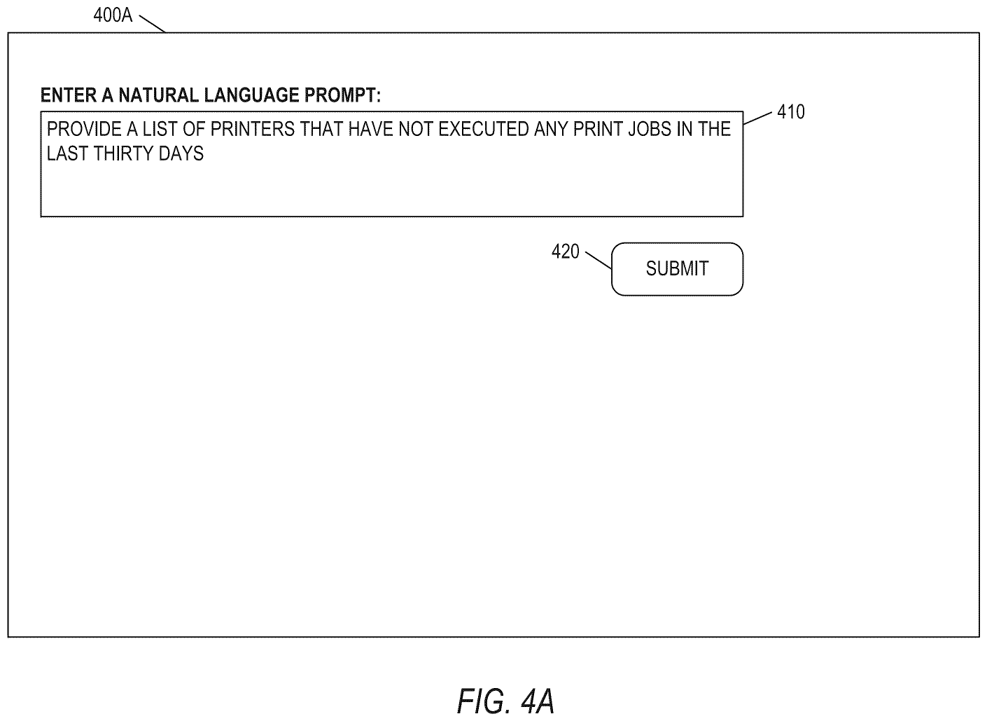

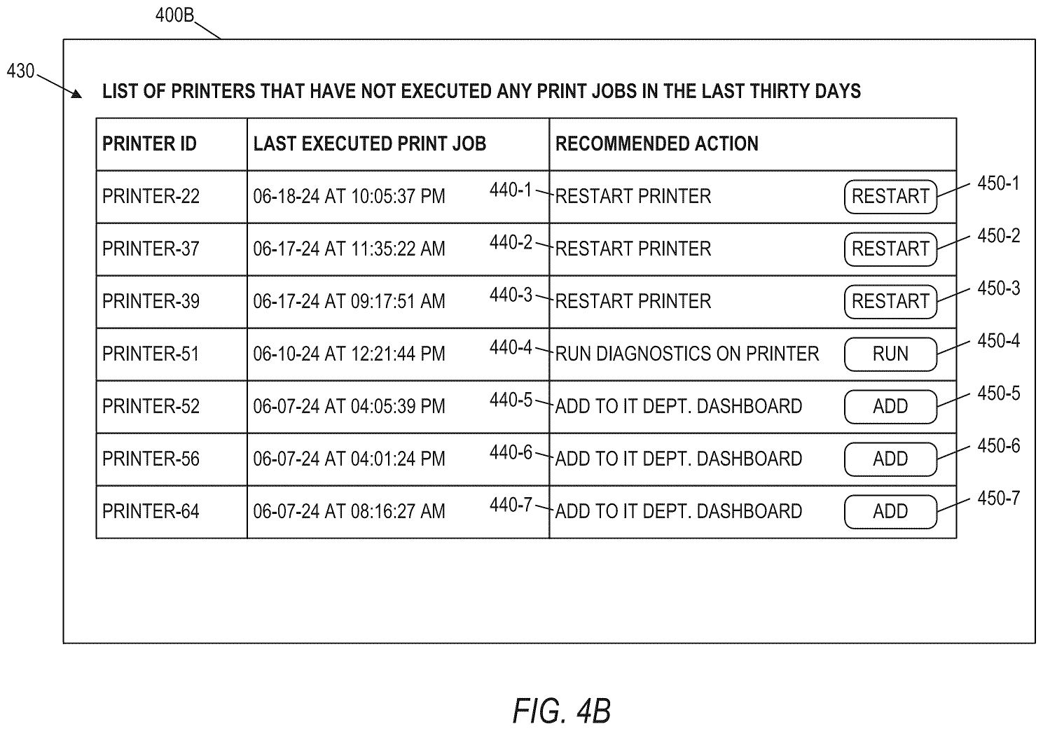

FIG. 4A illustrates an example GUI 400A in which user input is received in accordance with one or more embodiments. In the example illustrated in FIG. 4A, the GUI 400A includes a text field 410 in which a user has entered the natural language prompt “PROVIDE A LIST OF PRINTERS THAT HAVE NOT EXECUTED ANY PRINT JOBS IN THE LAST THIRTY DAYS.” The GUI 400A also includes a selectable button 420 configured to submit the natural language prompt entered into the text field 410 in response to a user selection of the selectable button 420.

In response to receiving the natural language prompt submitted by the user via GUI 400A, the system 100 may determine a user intent category corresponding to the natural language prompt, identify a particular process that corresponds to the user intent category, and execute the particular process as a response to the submission of the natural language prompt. For example, the system 100 may generate an instruction for the LLM 120 to determine a user intent category of the natural language prompt, and then submit the instruction to the LLM 120. The LLM 120 may determine the user intent category based on the natural language prompt. Next, the system 100 may receive the user intent category from the LLM 120, and then map the user intent category, received from the LLM 120, to a particular process of a set of processes. The system 100 may then execute the particular process in response to receiving the user input.

FIG. 4B illustrates an example GUI 400B in which a response to the user input is presented in accordance with one or more embodiments. In the example illustrated in FIG. 4B, the system 100 has determined a list of printers 430 that have not executed any print jobs in the last thirty days, such as by executing a database query, and has displayed the list of printers 430 in the GUI 400B. The list of printers 430 displayed in the GUI 400B includes a corresponding identification of each printer (e.g., in the column “PRINTER ID”) that has not executed any print jobs in the last thirty days, as well as a corresponding indication of when the printer last executed a print job, such as the date and time at which the printer last executed a print job (e.g., in the column “LAST EXECUTED PRINT JOB”).

Additionally, the system 100 may generate one or more recommendations for actions based on the user context after the user submitted the natural language prompt via the GUI 400A. The system 100 may generate the one or more recommendations for actions based on the natural language prompt submitted via the GUI 40A or based on an identification of the particular process executed by the system 100 in response to the natural language prompt. For example, the system 100 may generate one or more recommendations for actions based on the natural language prompt of the user requesting a list of printers that have not executed any print jobs in the last thirty days. Additionally or alternatively, the system 100 may generate one or more recommendations for actions based on the system 100 having executed a particular process to determine the list of printers that have not executed any print jobs in the last thirty days.

In the example shown in FIG. 4B, the GUI 400B displays a corresponding recommendation for an action 440 for each printer included in the list of printers 430. For example, for PRINTER-22, PRINTER-37, and PRINTER-39 included in the list of printers 430, the GUI 400B includes corresponding recommended actions 440-1, 440-2, and 440-3, which comprise recommendations to restart the corresponding printer. For PRINTER-51 included in the list of printers 430, the GUI 400B includes a corresponding recommended action 440-4, which comprises a recommendation to run a diagnostics program on the corresponding printer. For PRINTER-52, PRINTER-56, and PRINTER-64 included in the list of printers 430, the GUI 400B includes corresponding recommended actions 440-5, 440-6, and 440-7, which comprise recommendations to add the corresponding printer to a dashboard of an IT department in an IT management tool.

The GUI 400B also displays a corresponding selectable user interface element 450 that is configured to trigger execution of the corresponding recommended action in response to its selection. For example, for recommended actions 440-1, 440-2, and 440-3, the GUI 400B displays corresponding selectable user interface elements 450-1, 450-2, and 450-3, which are configured to trigger a restart of the corresponding printer in response to their selection. For recommended action 440-4, the GUI 400B displays a corresponding selectable user interface element 450-4, which is configured to trigger the running of a diagnostics program on the corresponding printer in response to its selection. For recommended actions 440-5, 440-6, and 440-7, the GUI 400B displays corresponding selectable user interface elements 450-5, 450-6, and 450-7, which are configured to trigger the addition of the corresponding printer to a dashboard of an IT department in an IT management tool.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

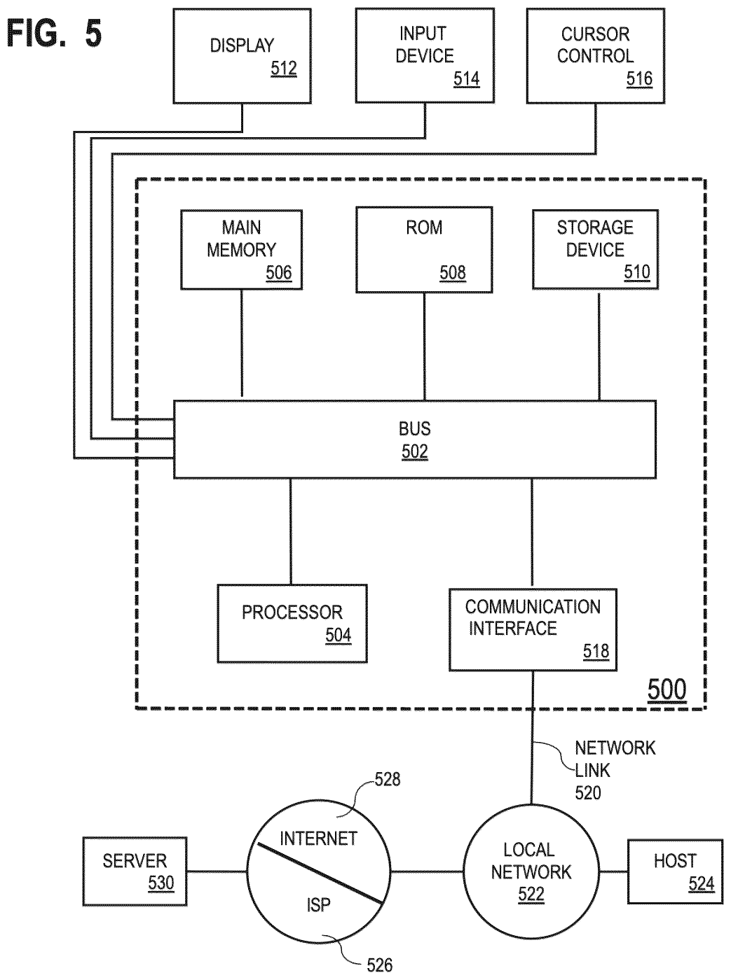

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 410. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 7. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, causes performance of operations comprising:
receiving a first user input comprising a first natural language prompt;
generating a first instruction for a Large Language Model (LLM) to determine a first user intent category of the first natural language prompt;
submitting the first instruction to the LLM, wherein the LLM determines the first user intent category based on the first natural language prompt;
receiving the first user intent category from the LLM;
mapping the first user intent category, received from the LLM, to a first particular process of a set of processes; and
executing the first particular process in response to receiving the first user input.

2. The media of claim 1, wherein mapping the first user intent category to the first particular process comprises applying a hash function to the first user intent category to select the first particular process.

3. The media of claim 1, wherein the first instruction identifies a plurality of pre-defined intent categories from which the LLM is to select the first user intent category, the plurality of pre-defined intent categories each being previously mapped to one of the set of processes.

4. The media of claim 1, wherein:
the first user intent category comprises an action command to apply a modification to a data repository; and
the first particular process comprises applying the modification to the data repository.

5. The media of claim 1, wherein:
the first user intent category comprises a request for information; and
the first particular process comprises presenting information on a computing device.

6. The media of claim 1, wherein:
the first user intent category comprises a database query; and
the first particular process comprises executing the database query.

7. The media of claim 6, wherein the executing of the database query comprises:
generating a second instruction for the LLM to generate the database query at least by:
executing an embedding operation to generate a first feature vector corresponding to the first natural language prompt;
comparing the first feature vector to each of a set of feature vectors corresponding respectively to a set of database schemas of a database to determine that a first subset of feature vectors, of the set of feature vectors, meets a first similarity criteria in relation to the first feature vector;
responsive to determining that the first subset of feature vectors meet the first similarity criteria in relation to the first feature vector: selecting a first subset of database schemas that correspond to the first subset of feature vectors for generation of the instruction; and
generating the second instruction to the LLM for the LLM to generate the database query, the second instruction specifying the first natural language prompt and the first subset of database schemas;
submitting the second instruction to the LLM for the LLM to generate the database query;
receiving the database query from the LLM, wherein the database query is based on and directed to the first subset of database schemas;
executing the database query on the database to generate a set of one or more results based on the first subset of database schemas; and
presenting the set of one or more results in response to the first natural language prompt.

8. The media of claim 1, wherein:
the first user intent category comprises a request for information to address an informational technology (IT) issue; and
the first particular process comprises presenting the information in response to the first natural language prompt.

9. The media of claim 8, wherein the presenting of the information comprises:
identifying, from a set of documents, one or more documents that are relevant to the IT issue based on a comparison of the one or more documents to the IT issue;
generating a second instruction to the LLM for the LLM to generate the information to address the IT issue, the second instruction including the first natural language prompt and the one or more documents;
submitting the second instruction to the LLM for the LLM to generate the information to address the IT issue;
receiving the information from the LLM; and
presenting the information in response to the first natural language prompt.

10. The media of claim 1, wherein:
the first user intent category comprises a query of vulnerabilities for a computing resource; and
the first particular process comprises presenting a response to the query of vulnerabilities for the computing resource in response to the first natural language prompt.

11. The media of claim 10, wherein the first particular process comprises:
identifying one or more attributes of the computing resource;
obtaining, from a Common Vulnerabilities and Exposures (CVE) database, information specifying one or more vulnerabilities based on the one or more attributes of the computing resource;
generating a second instruction to the LLM for the LLM to generate the response to the query of vulnerabilities for the computing resource, the second instruction including the first natural language prompt and the information specifying the one or more vulnerabilities;
submitting the second instruction to the LLM for the LLM to generate the response to the query;
receiving the response to the query from the LLM; and
presenting the response to the query in response to the first natural language prompt.

12. The media of claim 1, wherein the operations further comprise:
determining a user context that corresponds to the first natural language prompt or the first particular process;
generating a second instruction to the LLM for the LLM to generate a recommendation for an action, the second instruction including the user context;
submitting the second instruction to the LLM for the LLM to generate the recommendation for the action;
receiving the recommendation for the action from the LLM; and
presenting the recommendation for the action in response to the executing of the first particular process, the presenting of the recommendation for the action including presenting a selectable user interface element that is configured to trigger execution of the action in response to its selection.

13. The media of claim 12, wherein the action comprises installing software, uninstalling software, changing a configuration setting on a computing device, or adding a computing resource to a dashboard.

14. The media of claim 1, wherein the operations further comprise:
receiving a second user input comprising a second natural language prompt;
generating a second instruction for the LLM to determine a second user intent category of the second natural language prompt;
submitting the second instruction to the LLM, wherein the LLM determines the second user intent category based on the second natural language prompt;
receiving the second user intent category from the LLM;
mapping the second user intent category, received from the LLM, to a second particular process of the set of processes; and
executing the second particular process in response to receiving the second user input.

15. The media of claim 1, wherein the LLM determines a second user intent category based on the first natural language prompt, and the operations further comprise:
receiving a second user intent category from the LLM in response to the submitting the first instruction to the LLM, wherein the LLM determines the second user intent category based on the first natural language prompt;
mapping the second user intent category, received from the LLM, to a second particular process of the set of processes; and
executing the second particular process in response to receiving the first user input.

16. A method performed by at least one device including a hardware processor, the method comprising:
receiving a first user input comprising a first natural language prompt;
generating a first instruction for a Large Language Model (LLM) to determine a first user intent category of the first natural language prompt;
submitting the first instruction to the LLM, wherein the LLM determines the first user intent category based on the first natural language prompt;
receiving the first user intent category from the LLM;
mapping the first user intent category, received from the LLM, to a first particular process of a set of processes; and
executing the first particular process in response to receiving the first user input.

17. The method of claim 16, wherein mapping the first user intent category to the first particular process comprises applying a hash function to the first user intent category to select the first particular process.

18. The method of claim 16, wherein the first instruction identifies a plurality of pre-defined intent categories from which the LLM is to select the first user intent category, the plurality of pre-defined intent categories each being previously mapped to one of the set of processes.

19. The method of claim 16, wherein:
the first user intent category comprises an action command to apply a modification to a data repository; and
the first particular process comprises applying the modification to the data repository.

20. A system comprising:
at least one device including a hardware processor;
the system being configured to perform operations comprising:
receiving a first user input comprising a first natural language prompt;
generating a first instruction for a Large Language Model (LLM) to determine a first user intent category of the first natural language prompt;
submitting the first instruction to the LLM, wherein the LLM determines the first user intent category based on the first natural language prompt;
receiving the first user intent category from the LLM;
mapping the first user intent category, received from the LLM, to a first particular process of a set of processes; and
executing the first particular process in response to receiving the first user input.
